(19) United States
(12) Patent Application Publication
(10) Pub. No.: US 2026/0008095 A1
(43) Pub. Date: Jan. 8, 2026

(54) METHOD OF MANUFACTURING A PUSH ROD FOR A MOTOR VEHICLE STEERING SYSTEM AND PUSH ROD

(71) Applicants: ZF FRIEDRICHSHAFEN AG, Friedrichshafen (DE); ZF ACTIVE SAFETY GMBH, Koblenz (DE); ZF AUTOMOTIVE ITALIA S.R.L., Torino (IT)

(72) Inventors: Eduard Span, Koeln (DE); Ralf Völkl, Kronach (DE); Angelo Piantoni, Torino (IT); Jacopo Francesco Zini, Torino (IT); Christian Wassmer, Düsseldorf (DE); Heinz-Dieter Heitzer, Koblenz (DE); Rainer Engel, Krefeld (DE)

(21) Appl. No.: 19/256,458

(22) Filed: Jul. 1, 2025

(30) Foreign Application Priority Data
Jul. 4, 2024 (DE) 10 2024 206 304.5

(51) Int. Cl. B21K 1/06; B62D 3/12

(52) U.S. Cl. CPC B21K 1/066; B62D 3/126

(57) ABSTRACT

The invention relates to a method for producing a push rod (2) for a motor vehicle steering system (1), wherein a guide section (11) of the push rod (2) is formed with a non-circular and/or polygonal contour (12) for sliding guidance in the longitudinal direction of a central longitudinal axis (13) of the push rod (2) and for securing against rotation about the central longitudinal axis (13) of the push rod (2), by producing the contour (12) of the guide section (11) by means of a single manufacturing step in a provided blank. In order to enable a greater variety of contours when producing the contour (12) of the guide section (11) by means of the single manufacturing step, the method is characterized in that the contour (12) of the guide section (11) is formed by means of a warm forming or a cold hammer rolling forming.

### TECHNICAL FIELD

The invention relates to a method for producing a push rod for a motor vehicle steering system, wherein a guide section of the push rod is formed with a non-circular and/or polygonal contour for sliding guidance in the longitudinal direction of a central longitudinal axis of the push rod and for preventing rotation about the central longitudinal axis of the push rod, in that the contour of the guide section is produced in a provided blank by means of a single manufacturing step. Furthermore, the invention relates to a push rod produced in this way. Furthermore, the invention relates to a push rod for a motor vehicle steering system, wherein a guide section of the push rod is designed with a non-circular and/or polygonal contour for sliding guidance in the longitudinal direction of a central longitudinal axis of the push rod and for preventing rotation about the central longitudinal axis of the push rod, and the contour of the guide section has a plurality of concave and/or convex round-arch sections and/or circular-arc sections.

### BACKGROUND

Such a method is known, e.g., from DE 10 2022 207 245 A1. In this process, a final shape of a polygonal profile is completely contour rolled from a preform by roller burnishing.

A push rod with multiple concave and/or convex round-arch sections and/or circular-arch sections is known from DE 10 2018 214 039 A1.

For example, in electromechanical vehicle steering systems, a ball screw drive can be used to translate a drive torque of an electric motor of the vehicle steering system into an axial force on the push rod. The push rod is connected at its ends to the steered wheels of a motor vehicle via, for example, joints and/or tie rods. In this case, a torque acts on the push rod, which must be counteracted so that the push rod does not rotate around its central longitudinal axis. This torque must be reliably counteracted throughout the entire service life of the vehicle. Particularly with regard to steering behavior, only minimal angles of rotation of the push rod around its longitudinal axis may be permitted. On the other hand, appropriate torque support for the push rod should prevent friction in the steering from increasing or allow it to increase as little as possible.

A sliding guide can be provided to absorb the torque of the push rod. In particular, the push rod has a sliding guide section with the non-circular and/or polygonal contour. Preferably, the guide section is supported on a sliding guide with a counter contour formed correspondingly to the contour of the guide section. The sliding guide can be designed as a component of a steering gear housing and/or as a sliding bushing. In particular, the sliding bushing is fixedly attached to the steering gear housing. The sliding guide or the sliding bushing can be made of a low-friction plastic.

When producing the non-circular and/or polygonal contour of the guide section by means of roller burnishing, as known from DE 10 2022 207 245 A1, it is usually necessary to first produce a polygonal pre-profile. However, this requires several successive manufacturing steps, in particular using different tool devices, to produce the final shape of the guide section.

If the final contour of the guide section is produced in a single manufacturing step by means of roller burnishing, the problem may arise that not every desired contour, in particular with a desired surface quality, can be produced. There may be a risk that the contour grooves cannot be produced with the desired groove depth and/or groove width.

### SUMMARY

It is the object of the invention to further develop a method and/or a push rod of the type mentioned at the outset in such a way that a greater variety of contours is possible when producing the contour of the guide section by means of a single manufacturing step. Preferably, grooves with a greater groove depth and/or groove width should be produced by means of the individual manufacturing step. In particular, an alternative embodiment is to be provided.

The object of the invention is achieved with a method according to claim 1 and/or with a push rod according to claim 10 and/or 11. Preferred developments of the invention will be apparent from the dependent claims and the following description.

The method according to the invention is designed for producing a push rod for a motor vehicle steering system. In particular, a guide section of the push rod is formed with a non-circular and/or polygonal contour for sliding guidance in the longitudinal direction of a central longitudinal axis of the push rod and for preventing rotation about the central longitudinal axis of the push rod, in that the contour of the guide section is produced in a provided blank by means of a single manufacturing step. In particular, the production of a non-circular and/or polygonal preform is avoided. Thus, the desired, preferably final, contour of the guide section is produced directly in the provided blank and due to the single and/or individual manufacturing step. In particular, the single and/or individual manufacturing step comprises a one-time clamping of the blank in a tool device. Preferably, the single and/or individual manufacturing step comprises machining the blank with a single tool device. The tool device can be designed as a single station of a tool table. Thus, the contour of the guide section can be produced by means of a single and/or individual tool device and/or at a single station of a tool table.

According to the invention, the contour of the guide section is formed by means of warm forming or cold hammer rolling forming.

The advantage here is that, due to the production of the contour of the guide section by means of warm forming or cold hammer rolling, a greater variety of contours is possible also within the scope of the single and/or individual manufacturing step. In particular, grooves of the contour of the guide section can be produced with a greater groove depth and/or groove width.

According to a further development, the blank is provided with a round and/or circular cross-section, and the contour of the guide section is formed in the single manufacturing step by means of warm forming or cold hammer rolling forming. In particular, the blank is a round bar. Preferably, the push rod and/or the blank are formed from a metal. The guide section can be formed at one end of the push rod. Alternatively, the push rod can have multiple guide sections. For example, a guide section with the non-circular and/or polygonal contour can be formed at each of two opposite ends or end sections of the push rod. In particular, the push rod has a spindle section and/or threaded section next to or at a distance from the guide section. The spindle section and/or threaded section can be designed to cooperate with a spindle nut or a ball screw drive.

Preferably, due to the single manufacturing step for forming the contour by warm forming or cold hammer rolling forming, an at least partially or completely hardened surface is produced on the guide section. In particular, the surface of the guide section is harder and/or smoother compared to the non-machined surface of the blank. Warm forming and/or cold hammer rolling enables the production of a variety of different and/or complex non-circular and/or polygonal contours. Preferably, both forming methods enable high precision generation of the contour. This can result in improved load distribution. In particular, warm forming and/or cold hammer rolling ensure a high surface quality. This can lead to less wear, especially on the counter contour that interacts with the contour.

According to a further embodiment, the blank is heated to a temperature of 250° C. to 900° C. for warm forming. Preferably, the guide section is produced during warm forming by means of pressing or extrusion. In particular, warm forming results in a material or fiber profile that results in improved flexural strength and/or durability. Furthermore, residual stresses in the material can be reduced during warm forming. This can be advantageous for subsequent heat treatment and/or straightening processes.

According to a further development, in the cold hammer rolling forming process, the contour of the guide section is formed by means of at least two rollers arranged on opposite sides of the push rod, wherein the respective roller is guided on a rotational path so that the respective roller plastically deforms the surface of the push rod at the point of the rotational path closest to the push rod. The push rod is moved in the axial direction of the central longitudinal axis of the push rod in a manner suitable for the movement of the rollers. In particular, cold hammer rolling is designed as a so-called GROB-rolling. The advantage of cold hammer rolling is that no heat treatment is necessary, especially in the area of the guide section. Preferably, cold hammer rolling forming results in no or no significant deformation of the push rod with regard to its longitudinal alignment, so that subsequent aligning is not necessary.

Preferably, the blank has a round or circular cross-section, wherein the contour of the guide section is formed with multiple, preferably unprocessed, round-arch sections or circular-arch sections. In particular, during warm forming and/or cold hammer rolling, the entire surface of the guide section does not need to be treated or machined. Instead, only partial regions of the surface of the blank can be processed to form the contour of the guide section. This may result in several unprocessed round arch sections or circular arch sections remaining. For example, the contour is formed with six or eight round arch sections or circular arch sections. The plurality of, in particular unprocessed, round-arch sections or circular-arch sections can be evenly distributed around the outer circumference of the guide section or arranged mirror-symmetrically to at least or exactly one mirror plane. The mirror plane may be a central plane extending in the longitudinal direction of the push rod. Preferably, the outer circumference of the contour of the guide section is formed mirror-symmetrically to a first mirror plane and a second mirror plane, wherein the first mirror plane and the second mirror plane are oriented at right angles to each other. The first mirror plane and the second mirror plane may be center planes extending in the longitudinal direction of the push rod. In particular, the central longitudinal axis coincides with the first mirror plane and/or the second mirror plane, preferably with an intersection of the first and second mirror planes.

According to a further embodiment, the contour of the guide section is formed with a plurality of grooves aligned in the longitudinal direction of the push rod. The grooves can have a

U-shaped, C-shaped or V-shaped cross-section. The contour of the guide section is produced with a first type of groove and with a second type of groove. In particular, the contour of the guide section has exactly two types of grooves. Preferably, there is a respective round-arch section or a circular-arch section between two circumferentially adjacent grooves. For example, the contour of the guide section may have four grooves of a first groove type and four grooves of a second groove type. In the circumferential direction of the contour of the guide section, the two types of grooves can alternate. Alternatively, the contour of the guide section may have four grooves of the first groove type and two grooves of the second groove type. The two grooves of the second groove type can be mirror-symmetrical to each other.

According to a further development, the first groove type is formed with a first maximum groove depth and the second groove type with a second maximum groove depth. Here, the first maximum groove depth is greater than the second maximum groove depth.

Preferably, the first groove type is formed with a first maximum groove width and the second groove type is formed with a second maximum groove width. Here, the first maximum groove width is greater than the second maximum groove width.

Of particular advantage is a push rod which is produced using a method according to the invention and/or a motor vehicle steering system with such a push rod. In particular, the push rod has a spindle section and/or threaded section in addition to the guide section. The push rod can alternatively be referred to as a steering rod. Preferably, the push rod is a component of a motor vehicle steering system, in particular a steer-by-wire steering system.

Furthermore, a push rod for a motor vehicle steering system is advantageous, wherein a guide section of the push rod is designed with a non-circular and/or polygonal contour for sliding guidance in the longitudinal direction of a central longitudinal axis of the push rod and for preventing rotation about the central longitudinal axis of the push rod, and the contour of the guide section has a plurality of concave and/or convex round-arch sections and/or circular-arc sections. According to the invention, the contour of the guide section of this push rod has a plurality of grooves aligned in the longitudinal direction of the push rod, wherein at least one groove and/or at least one type of groove of the grooves each has at least one guide surface extending parallel to the central longitudinal axis of the push rod and having a planar or flat design. The at least one groove, in particular of the first groove type and/or the second groove type, can have two or three flat or planar guide surfaces.

The round arch section can have a changing radius. In particular, the round arch section is formed from several partial sections with different radii. Preferably, the circular arc section has a single and/or constant radius. The radius or the multiple radii can be determined from the central longitudinal axis of the push rod.

In particular, the groove is formed by means of multiple planar or flat guide surfaces that merge into one another. For example, the multiple flat or planar guide surfaces can merge into one another at an obtuse angle. Alternatively, the flat or planar guide surfaces can merge into one another by means of a concave transition.

A transition from a round-arch section and/or circular-arch section to a flat or planar guide surface can occur directly, in particular at an obtuse angle. Alternatively, a round-arch section and/or a circular-arch section can transition into the flat or planar guide surface by means of a convex transition.

The push rod and/or the motor vehicle steering system can be designed with the features mentioned in connection with the method. Furthermore, the method can be designed with the features mentioned in connection with the push rod.

### BRIEF DESCRIPTION OF THE DRAWINGS

The invention is explained in more detail below with reference to the figures. The same reference numerals refer to the same, similar or functionally identical components or elements. In the figures:

FIG. 1 shows a schematic representation of a motor vehicle steering system with a push rod according to the invention,

FIG. 2 shows a perspective side view of a push rod according to the invention,

FIG. 3 shows a schematic representation of a cold hammer rolling forming process for producing a push rod according to the invention,

FIG. 4 shows a cross section of the guide section of a push rod according to the invention with a first contour of the guide section, and

FIG. 5 shows a cross section of the guide section of a further push rod according to the invention with a further contour of the guide section.

### DESCRIPTION

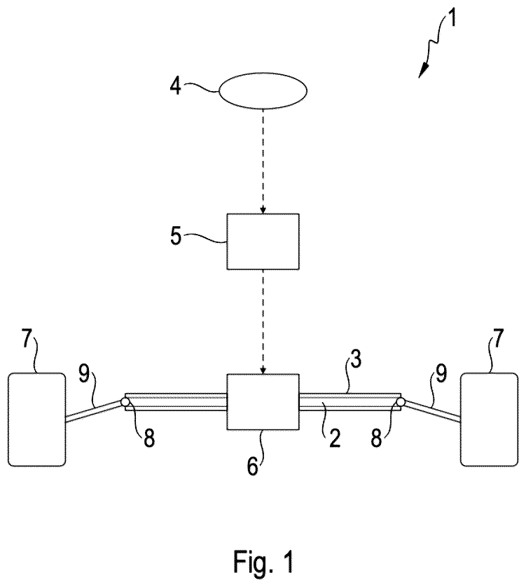

FIG. 1 shows a schematic representation of a motor vehicle steering system 1 with a push rod 2 according to the invention, the push rod 2 being shown only schematically here. The push rod 2 is arranged in a steering gear housing 3. In this exemplary embodiment, the motor vehicle steering system 1 is designed as a steer-by-wire steering system.

The motor vehicle steering system 1 has a steering handle 4, for example in the form of a steering wheel. Furthermore, the motor vehicle steering system 1 has a control device 5 and a steering gear 6. In this exemplary embodiment, no mechanical connection is realized between the steering handle 4 and the steering gear 6, by means of which a steering torque applied by a driver to the steering handle 4 can be transmitted to the steering gear 6. Rather, according to this exemplary embodiment, this is done electrically with the interposition of the control device 5, via which a steering signal triggered by the steering handle is transmitted.

The control device 5 converts this driver-side signal into a control signal for the steering gear 6, in particular an actuator arranged thereon, for example an electric motor, in order to ultimately transmit the driver-side steering command to vehicle wheels 7. For this purpose, the steering gear 6 has the push rod 2 coupled to the vehicle wheels 7, which is driven by the actuator or electric motor. According to this exemplary embodiment, corresponding tie rod joints 8 and tie rods 9 leading to the vehicle wheels 7 are provided for connecting the push rod 2 to the vehicle wheels 7.

Deviating from this exemplary embodiment, a mechanical coupling can be provided between the steering handle 4 and the steering gear 6, in particular the push rod 2 of the steering gear 6.

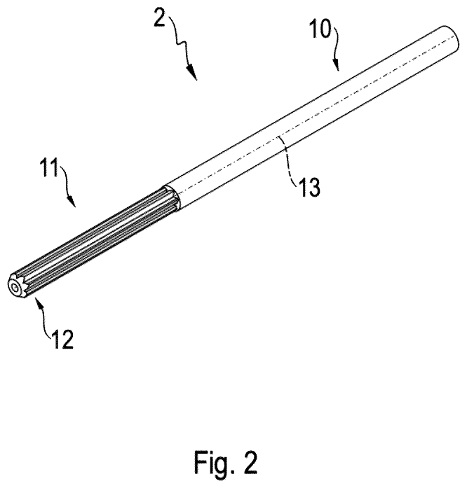

FIG. 2 shows a perspective side view of a push rod 2 according to the invention. The push rod 2 is made from a blank, which in this embodiment is a round metal rod. In this example, an unprocessed section 10 of the push rod 2 corresponds to the form of the blank. The push rod 2 has a guide section 11 with a non-circular or polygonal contour 12 for sliding guidance of the push rod 2 in the longitudinal direction of a central longitudinal axis 13 of the push rod 2 and for securing it against rotation about the central longitudinal axis 13 of the push rod 2. The non-circular or polygonal contour 12 results in particular with regard to a cross-section of the push rod 2. The sliding guide is designed with a counter-contour corresponding to the contour 12, which enables the push rod 2 to be displaced in the longitudinal direction of the central longitudinal axis 13. In this exemplary embodiment, the sliding guide is designed as a component of the steering gear housing according to FIG. 1.

The contour 12 of the guide section 11 is produced in a single manufacturing step in the previously provided blank. The contour 12 is formed by means of warm forming or cold hammer rolling.

In this exemplary embodiment, the guide section 11 is formed at one end or in an end region of the push rod 2. In addition, the push rod 2 can have a spindle section or threaded section, not shown in detail here, next to or at a distance from the guide section 11, here for example in a partial region of section 10. This spindle section or threaded section can be designed to cooperate with a spindle nut or a ball screw drive.

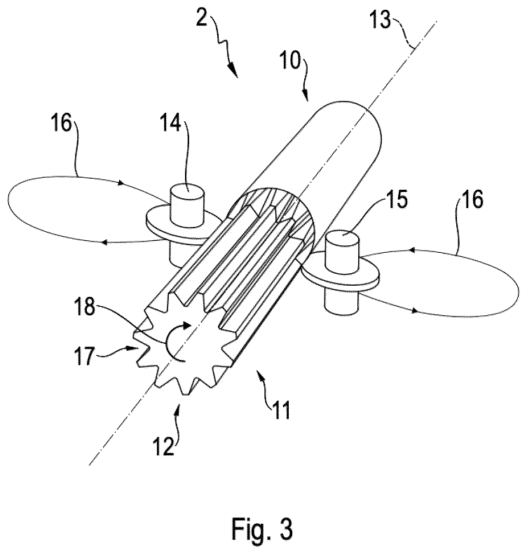

FIG. 3 shows a schematic representation of a cold hammer rolling forming process for producing a push rod 2 according to the invention, for example according to FIG. 2. The method for cold hammer rolling shown here can also be referred to as GROB rolling. In this exemplary embodiment, during cold hammer rolling forming, starting from the provided blank in the form of a round bar, the contour 12 of the guide section 11 is formed by means of at least two rollers 14, 15 arranged on oppositely directed sides of the push rod 2. Here, the respective roller 14 or 15 is guided on a rotational path 16. The rotational path 16 can, for example, be a circular path. The guidance of the rollers 14, 15 is such that the respective roller 14, 15 plastically deforms the surface of the push rod 2 at the nearest point of the rotational path 16 in relation to the push rod 2. In this case, the two opposing rollers 14, 15 touch the surface of the push rod 2 at the same time. Furthermore, the push rod 2 is moved in the axial direction of the central longitudinal axis 13 of the push rod 2 in accordance with the movement of the rollers 14, 15. As a result, a respective groove 17 is formed by means of a roller 14, 15, which groove extends parallel to the central longitudinal axis 13. In order to form further grooves 17, the push rod 2 is rotated in a suitable manner and as indicated by arrow 18 about the central longitudinal axis 13.

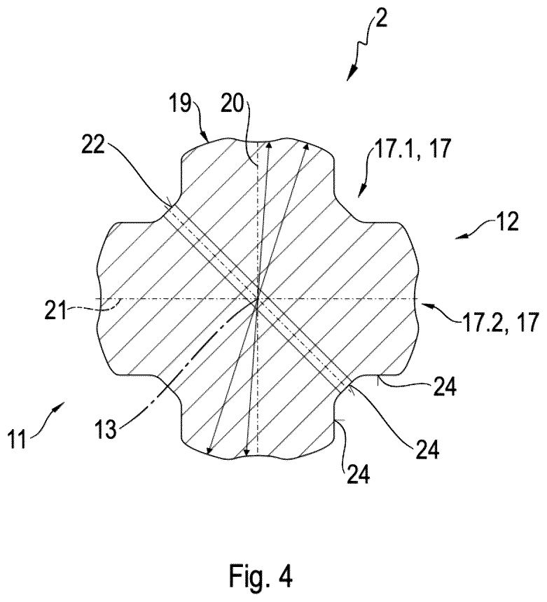

FIG. 4 shows a cross section of the guide section 11 of a push rod 2 according to the invention with a first contour 12 of the guide section 11. In this exemplary embodiment, the first contour 12 is produced by means of a cold hammer rolling forming process.

According to this example, the contour 12 of the guide section 11 has multiple circular arc sections 19. In this exemplary embodiment, a total of eight circular arc sections 19 are present, wherein for the sake of clarity not all circular arc sections 19 are provided with a reference numeral. The circular arc sections 19 lie on a common circle or radius around the central longitudinal axis 13. In this exemplary embodiment, the circular arc sections 19 are unprocessed sections or surface sections of the provided blank. Thus, during cold hammer rolling, not the entire surface of the guide section 11 is processed. Only part of the surface of the blank is processed to form the contour 12 of the guide section 11. As a result, the several unprocessed circular arc sections 19 remain as part of the contour 12 of the guide section 11.

In this example, the circular arc sections 19 are arranged mirror-symmetrically to a first mirror plane 20 and a second mirror plane 21. In this exemplary embodiment, the outer circumference of the contour 12 of the guide section 11 is also mirror-symmetrical to both the first mirror plane 20 and the second mirror plane 21. The first mirror plane 20 and the second mirror plane 21 are aligned at right angles to one another, wherein the first mirror plane 20 and the second mirror plane 21 are formed as central planes extending in the longitudinal direction of the push rod 2. Here, an intersection of the two mirror planes 20, 21 coincides with the central longitudinal axis 13.

In this exemplary embodiment, the contour 12 of the guide section 11 has a first groove type 17.1 and a second groove type 17.2. In this case, a groove 17 of the first groove type 17.1 and a groove 17 of the second groove type 17.2 alternate in the circumferential direction. A respective circular arc section 19 is arranged between two circumferentially adjacent groove types 17.1, 17, 2. In this example, the contour 12 has a total of four grooves 17 of the first groove type 17.1 and four grooves 17 of the second groove type 17.2. For better clarity, not all grooves 17 of groove type 17.1 or 17.2 are provided with a reference numeral.

The first groove type 17.1 is formed with a first maximum groove depth and the second groove type 17.2 with a second maximum groove depth, wherein according to this example the first maximum groove depth is greater than the second maximum groove depth.

Furthermore, the first groove type 17.1 is formed with a first maximum groove width and the second groove type 17.2 with a second maximum groove width, wherein according to this exemplary embodiment the first maximum groove width is greater than the second maximum

In this embodiment, each of the grooves 17 of the first groove type 17.1 is formed with an opening angle of 90° directed radially outwards relative to the central longitudinal axis 13. This results in a V-shaped cross-section for the respective groove 17 of the first groove type 17.1. The grooves 17 of the first groove type 17.1 have a flat groove base 22 in the area of the maximum groove depth. This groove base 22 is flat in this exemplary embodiment.

In this exemplary embodiment, the grooves 17 of the second groove type 17.2 are formed radially inwardly or concavely curved relative to the central longitudinal axis 13. This results in an arc-like or C-shaped cross-section for the respective groove 17 of the second groove type 17.2.

In this exemplary embodiment, the groove 17 of the first groove type 17.1 is formed by means of multiple, namely three in this example, planar or flat guide surfaces 24 which merge into one another. For the sake of clarity, the free guide surfaces 24 of only one of the four grooves 17 of the first groove type 17.1 are provided with reference numerals. In this example, the flat or planar guide surfaces 24 within the groove 17 of the first groove type 17.1 each merge into one another by means of a concave transition.

Furthermore, in this example, the circular arc section 19 immediately adjacent to the groove 17 of the first groove type 17.1 merges into the adjacent flat or planar guide surface 24 of the first groove type 17.1 by means of a convex transition.

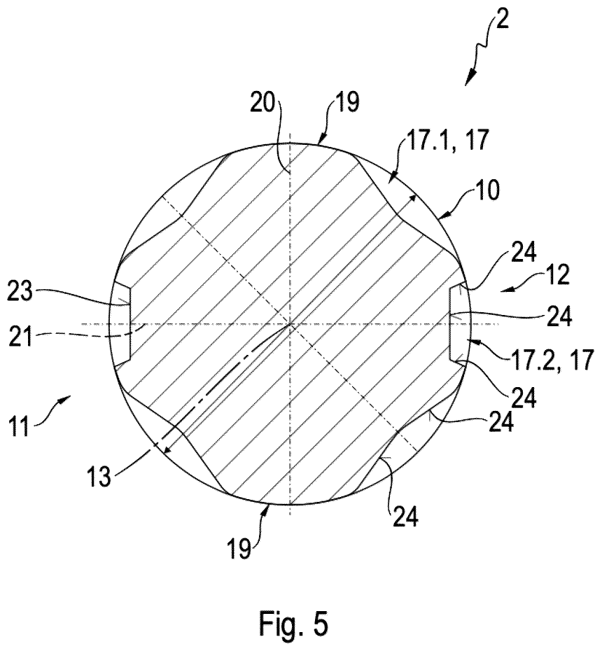

FIG. 5 shows a cross section of the guide section 11 of a further push rod 2 according to the invention with a further contour 12 of the guide section 11. In this exemplary embodiment, the first contour 12 is produced by means of a warm forming process. For this purpose, the provided blank was heated to a temperature of 250° C. to 900° C. Subsequently, the contour 12 of the guide section 11 was produced by pressing or extrusion.

Similar to the example according to FIG. 4, the contour 12 of the guide section 11 also has multiple circular arc sections 19 in the embodiment shown here. In this example, there are a total of two circular arc sections 19, which are arranged mirror-symmetrically to each other. The circular arc sections 19 lie on a common circle or radius around the central longitudinal axis 13. In this exemplary embodiment, the radius of the circular arc sections 19 corresponds to the radius of the blank or the unprocessed section 10 of the push rod 2.

In this example, the circular arc sections 19 are arranged mirror-symmetrically to a first mirror plane 20 and a second mirror plane 21. In this exemplary embodiment, the outer circumference of the contour 12 of the guide section 11 is also mirror-symmetrical to both the first mirror plane 20 and the second mirror plane 21. The first mirror plane 20 and the second mirror plane 21 are aligned at right angles to one another, wherein the first mirror plane 20 and the second mirror plane 21 are formed as central planes extending in the longitudinal direction of the push rod 2. Here, an intersection of the two mirror planes 20, 21 coincides with the central longitudinal axis 13.

In this exemplary embodiment, the contour 12 of the guide section 11 has a first groove type 17.1 and a second groove type 17.2. In this example, the contour 12 has a total of four grooves 17 of the first groove type 17.1 and two grooves 17 of the second groove type 17.2. A respective circular arc section 19 is arranged between two circumferentially adjacent grooves 17 of the first groove type 17.1. Furthermore, between two grooves 17 of the first groove type 17.1 and facing away from the two circular arc sections, a respective groove 17 of the second groove type 17.2 is formed. Here, the grooves 17 of the second groove type 17.2 are mirror-symmetrical to the first mirror plane. In this exemplary embodiment, a pair of grooves 17 of the first groove type 17.1 and the pair of grooves 17 of the second groove type 17.2 are formed mirror-symmetrically to each other. For better clarity, not all grooves 17 of groove type 17.1 or 17.2 are provided with a reference numeral.

The first groove type 17.1 is formed with a first maximum groove depth and the second groove type 17.2 with a second maximum groove depth, wherein according to this example the first maximum groove depth is greater than the second maximum groove depth.

Furthermore, the first groove type 17.1 is formed with a first maximum groove width and the second groove type 17.2 with a second maximum groove width, wherein according to this exemplary embodiment the first maximum groove width is greater than the second maximum

In this exemplary embodiment, each of the grooves 17 of the first groove type 17.1 is formed with an opening angle of 160° directed radially outwards relative to the central longitudinal axis 13. This results in a flattened V-shaped cross-section for the respective groove 17 of the first groove type 17.1.

The grooves 17 of the second groove type 17.2 have a flat groove base 23 in the region of maximum groove depth. This groove base 23 is flat in this exemplary embodiment. Opposite inner walls of the grooves 17 of the second groove type 17.2 are directed radially inwards and towards each other obliquely to the central longitudinal axis 13, the inner walls merging into the groove base 23. In this exemplary embodiment, the groove 17 of the first groove type 17.1 and the groove 17 of the second groove type 17.2 merge into one another in a transition region, wherein the transition region has a maximum radius in relation to the central longitudinal axis 13, which corresponds to the radius of a circular arc section 19.

In this exemplary embodiment, the groove 17 of the first groove type 17.1 is respectively formed by means of multiple, namely three in this example, planar or flat guide surfaces 24 which merge into one another. For the sake of clarity, the two guide surfaces 24 of only one of the four grooves 17 of the first groove type 17.1 are provided with reference numerals. In this example, the two flat or planar guide surfaces 24 within the groove 17 of the first groove type 17.1 merge into one another by means of a concave transition.

Furthermore, in this example, the circular arc section 19 immediately adjacent to the groove 17 of the first groove type 17.1 merges into the adjacent flat or planar guide surface 24 of the first groove type 17.1 by means of a convex transition.

In this exemplary embodiment, the groove 17 of the second groove type 17.2 is respectively formed by means of multiple, namely three in this example, planar or flat guide surfaces 24 which merge into one another. For the sake of clarity, the three guide surfaces 24 of only one of the two grooves 17 of the second groove type 17.2 are provided with reference numerals. In this example, the flat or planar guide surfaces 24 within the groove 17 of the first groove type 17.2 merge into one another at an obtuse angle.

Furthermore, in this example, the circular arc section 19 immediately adjacent to the groove 17 of the second groove type 17.2 merges into the adjacent flat or planar guide surface 24 of the second groove type 17.2 by means of a convex transition.

### REFERENCE NUMERALS

1 motor vehicle steering system
2 push rod
3 steering gear housing
4 steering handle
5 control device
6 steering gear
7 vehicle wheel
8 tie rod joint
9 tie rod
10 unprocessed section
11 guide section
12 contour
13 central longitudinal axis
14 roller
15 roller
16 rotational path
17 groove
17.1 first groove type
17.2 second groove type
18 arrow
19 circular arc section
20 first mirror plane
21 second mirror plane
22 groove base
23 groove base
24 guide surface

1. A method for producing a push rod (2) for a motor vehicle steering system (1), wherein a guide section (11) of the push rod (2) is formed with a non-circular and/or polygonal contour (12) for sliding guidance in the longitudinal direction of a central longitudinal axis (13) of the push rod (2) and for securing against rotation about the central longitudinal axis (13) of the push rod (2), by producing the contour (12) of the guide section (11) by means of a single manufacturing step in a provided blank, wherein the contour (12) of the guide section (11) is formed by means of warm forming or cold hammer rolling forming.

2. The method according to claim 1, wherein the blank is provided with a round and/or circular cross-section, and the contour (12) of the guide section (11) is formed in the single manufacturing step by means of warm forming or cold hammer rolling forming.

3. The method according to claim 1, wherein due to the single manufacturing step for forming the contour (12) by warm forming or cold hammer rolling forming on the guide section (11) an at least partially hardened surface is produced.

4. The method according to claim 1, wherein the blank is heated to a temperature of 250° C. to 900° C. for the warm forming, in particular the guide section (11) is produced by means of pressing or extrusion during the warm forming.

5. The method according to claim 1, wherein the cold hammer rolling forming the contour (12) of the guide section (11) is formed by means of at least two rollers (14, 15) arranged on opposite sides of the push rod (2), wherein the respective roller (14, 15) is guided on a rotational path (16) so that the respective roller (14, 15) plastically deforms the surface of the push rod (2) at the closest point on the rotational path (16) to the push rod (2), and the push rod (2) is moved in the axial direction of the central longitudinal axis (13) of the push rod (2).

6. The method according to claim 1, wherein the blank has a round or circular cross-section, wherein the contour (12) of the guide section (11) is formed with a plurality of, preferably unprocessed, round-arch sections or circular-arch sections (19), in particular the contour (12) is formed with six or eight round-arch sections or circular-arch sections (19).

7. The method according to claim 1, wherein the contour (12) of the guide section (11) is formed with a plurality of grooves (17) aligned in the longitudinal direction of the push rod (2), wherein the contour (12) of the guide section (11) is produced with a first type of groove (17.1) and with a second type of groove (17.2).

8. The method according to claim 7, wherein the first groove type (17.1) is formed with a first maximum groove depth and the second groove type (17.2) is formed with a second maximum groove depth, wherein the first maximum groove depth is greater than the second maximum groove depth.

9. The method according to claim 7, wherein the first groove type (17.1) is formed with a first maximum groove width and the second groove type (17.2) is formed with a second maximum groove width, wherein the first maximum groove width is greater than the second maximum groove width.

10. A push rod, produced by a method according to claim 1.

11. A push rod for a motor vehicle steering system (1), wherein a guide section (11) of the push rod (2) is designed with a non-circular and/or polygonal contour (12) for sliding guidance in the longitudinal direction of a central longitudinal axis (13) of the push rod (2) and for securing against rotation about the central longitudinal axis (13) of the push rod (2), and the contour (12) of the guide section (11) has a plurality of concave and/or convex round-arch sections and/or circular-arc sections (19), wherein the contour (12) of the guide section (11) has a plurality of grooves (17) aligned in the longitudinal direction of the push rod (2), wherein at least one groove (17) and/or at least one type of groove (17.1, 17.2) of the grooves (17) each has at least one flat guide surface (24) extending parallel to the central longitudinal axis (13) of the push rod (2).
